(19) United States
(12) Patent Application Publication
(10) Pub. No.: US 2026/0214069 A1
(43) Pub. Date: Jul. 23, 2026

(54) SYSTEMS AND METHODS PROVIDING DOMAIN-SPECIFIC CROSS-CONVERSATION ANALYSIS FOR HOLISTIC AUTOMATED CONTROL OVER WORKFLOWS

(71) Applicant: RingCentral, Inc., Belmont, CA (US)

(72) Inventors: Naresh Annepu, Bangalore (IN); Sushant Hiray, Redwood City, CA (US); Prashant Kukde, Milpitas, CA (US); Siddharth Krishna Kumar, Bengaluru (IN); Mohit Tare, Bengaluru (IN)

(73) Assignee: RingCentral, Inc., Belmont, CA (US)

(21) Appl. No.: 19/087,902

(22) Filed: Mar. 24, 2025

(30) Foreign Application Priority Data
Jan. 22, 2025 (IN) 202541005232

(51) Int. Cl. H04L 51/02; G06F 40/35

(52) U.S. Cl. CPC H04L 51/02; G06F 40/35

(57) ABSTRACT

A conversation controller provides autonomous control over conversations occurring in an organization. The conversation controller monitors the conversations and detects first trackers in first and second conversations, and second trackers in third and fourth conversations. The conversation controller updates a first customer lifecycle based on the trackers from the first and third conversations and the first and third conversations involving a first customer. Similarly, the conversation controller updates a second customer lifecycle based on the trackers from the second and fourth conversations and the second and fourth conversations involving a common second customer. The conversation controller detects an issue at a particular stage of a workflow based on a natural language understanding of dialogue from the third and fourth conversations that map to the particular workflow stage, and performs a modified action at the particular workflow stage in an active conversation in resolution of the issue.

### CROSS-REFERENCE TO RELATED APPLICATIONS

This application claims priority to India Application No. 202541005232 filed January 22, 2025 domestically in the country of India, the entire contents of which are incorporated herein by reference.

### TECHNICAL FIELD

The present disclosure relates to the fields of audio and video conferencing and telecommunications. Specifically, the present disclosure relates to systems and methods for automatically monitoring conversations between different participants in order to provide domain-specific cross-conversation holistic workflow insights and automated conversation controls.

### BACKGROUND

A call center has multiple conversations happening at any given time between agents and customers or contacts. Managers or other personnel with an oversight role are unable to listen or review every conversation that is made by every agent in the call center, and therefore have limited view of agent performance and operational effectiveness.

Conversational monitoring systems perform the conversation monitoring on behalf of the managers. The conversational monitoring systems analyze each conversation independently and according to the same rules. In other words, the conversational monitoring systems analyze all conversations of an organization in the same way regardless of the purpose of each conversation and whether the conversations occur in different departments, teams, or with different agents that have different roles (e.g., sales, technical support, etc.).

The analytics produced by these conversational monitoring systems are conversation-specific rather than workflow-specific. The analytics identify the events that occurred during a conversation and are usually focused on agent and customer behaviors (e.g., who spoke longer, how many interruptions, how many questions, sentiment analysis, etc.). No insight is provided regarding customer satisfaction, the customer lifecycle, overall agent performance, or the execution or completion rate for the different workflows being effectuated in the conversations. No automated controls or actions are performed to improve the customer satisfaction, the progression through the customer lifecycle, the overall agent performance, or the execution or completion rate of the workflows.

### BRIEF DESCRIPTION OF THE DRAWINGS

FIG. 1 illustrates an example of a domain-specific cross-conversation analysis and automated holistic workflow control in accordance with some example embodiments presented herein.

FIG. 2 illustrates an example architecture for a conversation controller in accordance with some example embodiments presented herein.

FIG. 3 illustrates an example of scoring a conversation in accordance with some example embodiments.

FIG. 4 illustrates an example interface for a conversation score generated by the conversation controller in accordance with some example embodiments presented herein.

FIG. 5 presents a process for dynamically adapting the conversation evaluation according to manually and automatically detected changing conversation dynamics and priorities in accordance with some example embodiments presented herein.

FIG. 6 illustrates an example of consolidated insights that are generated in accordance with some example embodiments presented herein.

FIG. 7 illustrates an example of an automatically generated customer satisfaction report in accordance with some example embodiments presented herein.

FIG. 8 presents a process for automating control over conversations associated with one or more workflows based on generated conversational intelligence funnels in accordance with some example embodiments presented herein.

### DETAILED DESCRIPTION OF PREFERRED EMBODIMENTS

This disclosure arises from the realization that monitoring individual conversations independent of one another or in isolation greatly restricts the insights that may be extracted from the conversations and the controls that may be implemented to improve the conversations. While effective in summarizing the events that occurred in each conversation or identifying how the conversation participants acted during the conversation, the events and resulting summaries have no impact or effect on the business objectives that are the impetus behind each conversation.

The current disclosure provides a technical solution for a technological problem in the field of audio and video conferencing and telecommunications. The technical solution involves performing automated monitoring of the conversations that occur throughout different departments, teams, or roles of an organization, and automating control over the conversations based on a domain-specific cross-conversation analysis of the conversations.

To differentiate from conversational monitoring systems of the prior art system that perform the same independent and isolated analysis of all conversations using the same rules, the technical solution implements a differentiated domain-specific cross-conversation analysis of conversations that take place in a common domain and that involve the same workflow and/or the same customer in different conversations. The technical solution merges artificial intelligence (AI) with a human feedback loop to determine the different events, actions, triggers, or other trackers that are relevant or important for the analysis of conversations occurring in different domains and that are used for a contextual analysis of related conversations that advance a customer lifecycle through a given workflow of the business or organization. The domain-specific cross-conversation analysis involves using the primary events, actions, or triggers associated with a given domain to generate metrics and/or insights that are specific for that given domain from conversations classified to the given domain. In other words, the monitoring and analysis changes for conversations occurring in different domains based on automated and manually changing dynamics and priorities associated with each domain.

Automating control over the conversations includes generating actionable insights for dynamically changing business workflows that are specific to different domains within an organization. In some example embodiments, the actionable insights include holistic agent reports that identify trends, patterns, or commonality from multiple conversations involving the same agent. The trends, patterns, or commonality are unbiased by one-off conversations and serve as inputs to generative AI that automatically generates and provides customized training or coaching for the agent based on the identified trends, patterns, or commonality. The technical solution involves customizing the training or coaching based on a holistic analysis of each agent meeting specific business objectives in past conversations and their determined strengths and weaknesses. The generative AI may also use the identified trends, patterns, or commonality to train chatbots and/or control the automatically generated responses that chatbots provide in response to different customer inquiries.

In some example embodiments, the actionable insights include automatically generated domain-specific customer satisfaction (CSAT) scores and reports. In some such example embodiments, the technical solution involves generating and supporting the CSAT scores and reports based on dialog, text, and/or other data from a conversation without the customer from that conversation directly responding to the CSAT questions or prompts and without the need to follow up with the customer after the conversation has concluded.

In some example embodiments, the actionable insights track the customer lifecycle through a domain-specific workflow based on insights for the customer that are connected across different conversations taking place at different times and/or with different agents. In some such example embodiments, the actionable insights include scores that are computed based on detected interactions at each stage of the customer lifecycle or each stage of the domain-specific workflow and are validated or corroborated based on extracted or linked conversation segments that affect the score and/or advancement through the domain-specific workflow.

The technical solution leverages AI to detect trends, commonality, and/or patterns across the actionable insights that are generated for the different customer lifecycles and/or domain-specific workflows and to implement automated actions to improve the workflows, the effectiveness of the agents, minimize customer churn, maximize customer retention, maximum customer conversion, and overall improve business efficiency, productivity, and profitability based on the detected trends, commonality, and/or patterns. The automated actions may include dynamically modifying the domain-specific workflows to remove pain points or issues identified across different conversations, customer lifecycles, and/or domain-specific workflows. The automated actions may include modifying operations of bots (e.g., chatbots) that interact with the customers to provide better and more effective responses to the customers and to improve customer engagement. The automated actions may include providing real-time conversation support to agents via dynamically generated content that is automatically presented during the conversation or that is presented to guide or direct the agent.

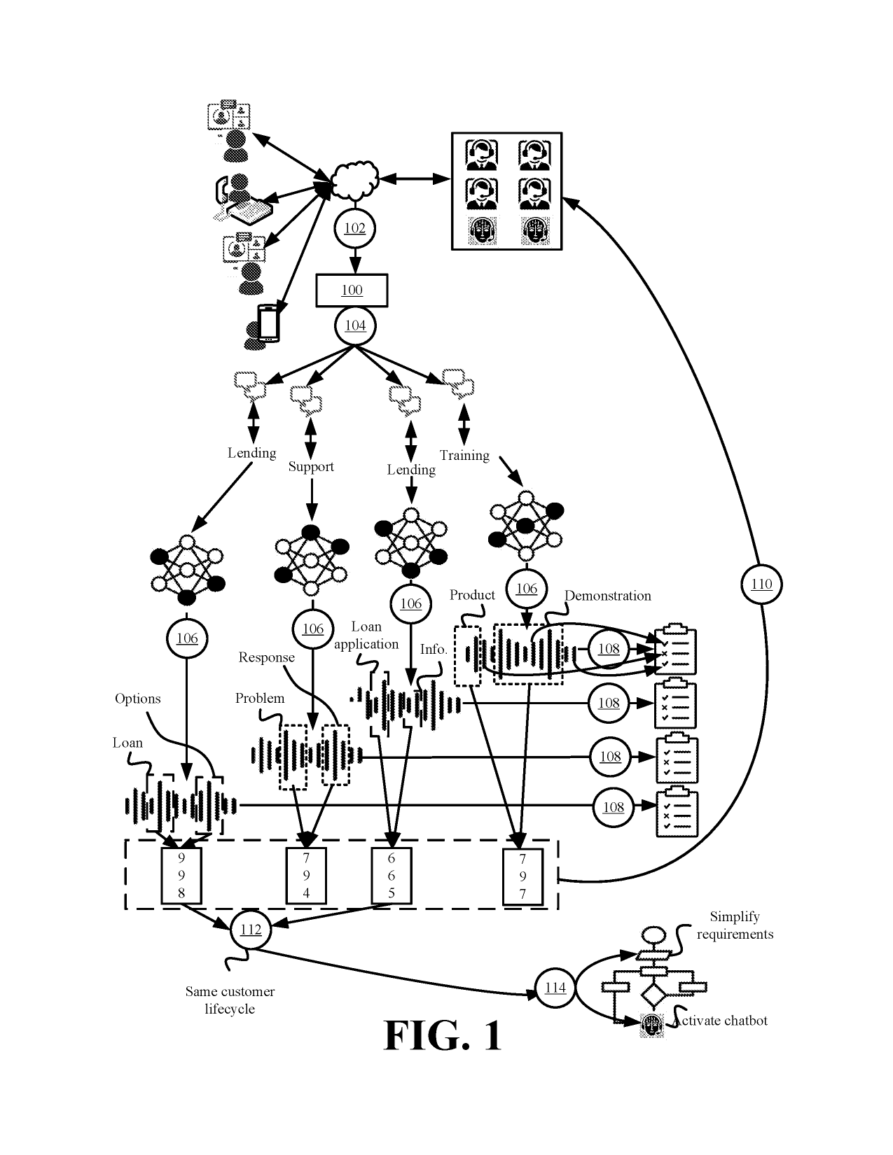

FIG. 1 illustrates an example of the domain-specific cross-conversation analysis and automated holistic workflow control in accordance with some example embodiments presented herein. Conversation controller 100 monitors (at 102) each conversation taking place in an organization or with different departments, teams, or groups of the organization. The conversations may include audio and/or video that is routed across Plain Old Telephone Service (POTS) or a telecommunications service provider network. The conversations may also include emails, text messages, and/or other content that is transmitted over a data network.

In some example embodiments, conversation controller 100 is granted access to passively monitor (at 102) each conversation. For instance, video, audio, textual, and/or other data feeds from each conversation may be forwarded to conversation controller 100.

In some example embodiments, conversation controller 100 is integrated as part of a conferencing system that hosts, establishes, or routes the different conversations. The conferencing system may provide audio and/or video conferencing services, automated dialers, telephony or conferencing equipment, and/or hardware or software for connecting agents to other users. In some such example embodiments, conversation controller 100 may receive the feeds from the different conference equipment or from the conference system.

Conversation controller 100 defines (at 104) a directional anchor for each conversation. Defining (at 104) the directional anchor includes classifying each conversation and assigning one or more identifiers to each conversation based on the classification. The classification may be based on an identification of the conversation participants (e.g., identification of the conversation participant roles), content that is shared during the conversation, subject matter or topics referenced in the conversation, classifications associated with the devices that are used by the conversation participants, contacted telephone number, Uniform Resource Locator (URL), another identifier by which one or more participants join a conference, geographic information, time-of-day, and/or other data from the conversation or that is associated with the conversation. The directional anchor may identify the department, team, role, product, service, workflow, or other domain that the conversation relates to.

Conversation controller 100 associates (at 106) contextually relevant metrics to different parts of each conversation based on detected domain-specific trackers that are defined for or associated with the conversation classification. Conversation controller 100 may use a Large Language Model (LLM) to analyze the conversations with the domain-specific trackers. The domain-specific trackers provide the LLM with context for parts of the conversation that may otherwise have ambiguous or multiple meanings or interpretations without the context. The domain-specific trackers that are automatically generated and associated with the queries (e.g., conversation analysis) enhance the LLM to operate as a Directionally Anchored-LLM (DA-LLM). Accordingly, subsequent references to the DA-LLM include an LLM that receives queries that are supplemented with the domain-specific trackers by the conversation controller 100 in order to provide the additional context for the DA-LLM to analyze input based on training data from a specific domain that is associated with the context without having to train different domain-specific LLMs. The contextually relevant metrics provided by the DA-LLM are identifiers, statistics, analytics, and/or other data derived from specific segments of a conversation that are relevant or affect the analysis of the conversation within a specific domain. The domain-specific trackers correspond to keywords, expressions, phrases, sentiment, actions, events, or other triggers that are of value in the analysis of the conversation within the context of the specific domain. For instance, the contextually relevant metrics for a sales conversation may include conversation segments where pricing, order information, and/or reasons the sale was not completed are discussed, whereas the contextually relevant metrics for a support conversation may include conversation segments where problems and solutions to the problems are discussed.

Conversation controller 100 generates (at 108) a CSAT report for each conversation without human input. Conversation controller 100 generates (at 108) the CSAT report by using the DA-LLM to answer a questionnaire using the contextually relevant metrics and/or other extracted data from the conversations that support the answers. More specifically, conversation controller 100 uses the DA-LLM to perform a natural language understanding (NLU) of the conversation and the customer’s engagement and/or reaction to the conversation, identifies relevant segments from the conversation that pertain or relate to specific questions from the questionnaire, and answers the questions based on an analysis of the sentiment, content, and/or statements made in the identified segments. For instance, a first question may ask “How knowledgeable was the agent?” The DA-LLM may search the conversation to detect questions that are posed by the customer and the accuracy of the agent’s answer to those questions. Other data for answering the first question may include the number of follow-up questions that the customer had pertaining to the same subject or topic as the first question, whether the customer seemed confused by the response or indicated a clear understanding of the agent response, the customer tone or behavior after receiving the response, and/or other audio or visual cues.

The generated (at 108) CSAT report includes textual responses to each question of the questionnaire with answers that are derived from or that reference the identified segments of the conversations from which the answers are generated.

The questionnaire used to generate (at 108) each CSAT report may be domain specific. For instance, the CSAT report for a sales conversation may include different questions than the CSAT report for a technical support conversation.

Conversation controller 100 scores each conversation according to different factors that are relevant for the determined conversation classification. The conversation scoring provides different insights than the CSAT report. The CSAT reports are measures of the customer satisfaction according to different factors of customer satisfaction defined for different conversation classifications. The conversation scores are measures of the agent performance and/or meeting different business objectives set forth for different conversation classifications.

In some embodiments, the scoring and determination of the relevant factors for each classification is performed by the DA-LLM. For instance, the DA-LLM may score a first conversation based on a first set of factors that are associated with a first directional anchor and/or a first conversation classification, and may score a second conversation based on a second set of factors that are associated with a second directional anchor and/or a second conversation classification.

The DA-LLM may automatically identify the factors that are relevant for the different classifications or different directional anchors. The DA-LLM may analyze multiple conversations with the same classification to detect recurring patterns, trends, or commonality in those conversations, extract factors within the recurring patterns, trends, or commonality, and to assess the importance or impact that the extracted factors on the conversation outcome. In some embodiments, the DA-LLM may include incorporating a human feedback loop. The human feedback loop may include modifications that users make to the AI-generated factors and/or manually defined factors to include as part of the conversation score. In any case, conversation controller 100 generates different scorecards for conversations pertaining to different domains or classifications.

Conversation controller 100 generates (at 110) customized coaching models for each agent based on conversation scores from multiple conversations that the agent participated in. The customized coaching model provides each agent with targeted insights as to their strengths and weaknesses, and also actions that the agent is to implement and/or perform in future conversations to resolve the weaknesses. The customized coaching model may provide personalized coaching tips that focus on the agent’s individual strengths and weaknesses, and that the agent may implement to improve their effectiveness and success rate in future conversations.

Conversation controller 100 tracks (at 112) a customer or workflow lifecycle according to the monitored conversations and the conversation analysis. Tracking (at 112) the lifecycle includes identifying different conversations that involve at least one common participant and that relate to the same workflow. For instance, conversation controller 100 may identify the same customer participating in different conversations that take place over a period of one week and that relate to completing the same workflow. More specifically, a first conversation between a first agent and a customer may include a discussion about different loan options, a second conversation between a second agent and the customer may involve collect the customer information for a loan application, a third conversation between a third agent and the customer may include a follow-up call to describe different funding options that the customer is approved for, and a fourth conversation between a fourth agent and the customer may include a confirmation call to notify the customer that the funding has been issued. Conversation controller 100 analyzes these conversations, determines that they are related to the same workflow, and associates each conversation to a different stage in the workflow lifecycle.

Conversation controller 100 performs (at 114) dynamic actions according to a holistic analysis of the tracked (at 112) workflows. The holistic analysis includes comparing the progressions of the same workflow lifecycle by different customers to identify the workflow completion rate and/or different sets of customers that reached different stages of the workflow. Conversation controller 100 analyzes the conversations for the last reached stage of each workflow, and detects the reasons or causes by which the workflows stalled or ended at the various stages. The dynamic actions performed (at 114) by conversation controller 100 include modifying the workflow stages, generating content to simplify progression through the stages, and/or modifying chatbot operation to address the reasons or causes for the incomplete workflows.

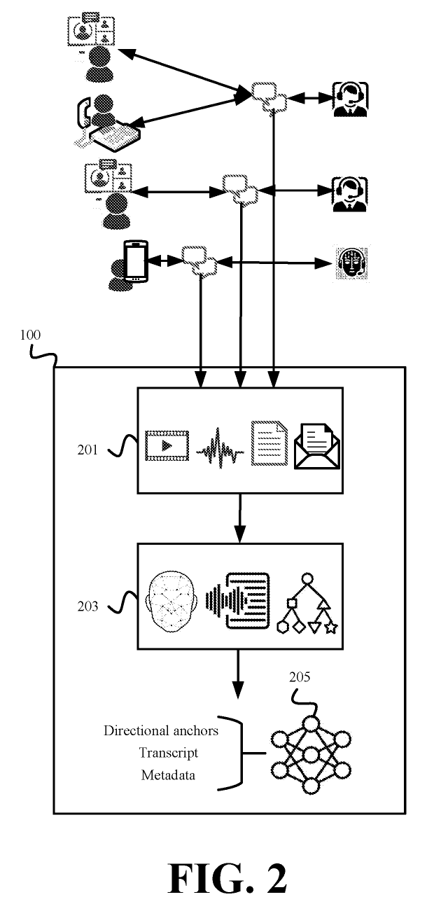

FIG. 2 illustrates an example architecture for conversation controller 100 in accordance with some example embodiments presented herein. Conversation controller 100 includes conversation monitor 201, conversation processor 203, and DA-LLM 205.

Conversation monitor 201 receives each conversation that takes place within an organization over one or more communication channels. The communication channels include telephone calls, audio and/or video conferences, text exchanges (e.g., emails, text messages, instant messages, etc.), and/or other supported forms of communication. Conversation monitor 201 may receive audio, video, textual, and/or other data feeds associated with each conversation. In some embodiments, conversation monitor 201 receives the feeds directly from the devices (e.g., dialers) that the agents of an organization use to participate in the conversations, from a conference provider, and/or from other hosts or systems that provide the one or more communication channels.

In addition to receiving these different feeds, conversation monitor 201 may receive metadata or identifying information for each conversation. The metadata may indicate the telephone number that was called, the URL that was used to access the conversation, device identifying information (e.g., network addresses, device signatures, software versions, etc.), geolocation information, user profiles accessed after a user login, usernames, and/or other information that may be obtained as different conversation participants join, connect, register, or participate in a conversation.

Conversation processor 203 transcribes the audio associated with any conversation. Specifically, conversation processor 203 performs a speech-to-text conversion of each conversation audio feed. Conversation processor 203 may also perform a sentiment analysis of the conversation audio and/or video feeds. The sentiment analysis may include analyzing the audio of the conversation to measures speaking rates, changes in tone, pitch, and volume, and/or other audio characteristics and to correspond the measurements to different sentiment (e.g., angry, happy, bored, interested, confused, etc.). In some embodiments, the sentiment analysis may include analyzing the conversation video to correlate facial expression and body language to different sentiment, and thereby supplement and/or verify the sentiment that is extracted from the conversation audio.

Conversation processor 203 performs a NLU analysis of the transcript and/or dialogue in order to determine the subject matter or topics of the conversation and to classify the conversation to one of several defined domains or classifications. Classifying the conversation includes associating one or more directional anchors to the conversation, wherein the directional anchors are identifiers or tags that specify the classification. In some example embodiments, the conversation metadata and/or other data associated with the conversation (e.g., shared content) may be used to perform or supplement the classification. For instance, conversation processor 203 may base the classification on the role of the agent that participates in the conversation and certain keywords or topics associated with the classification being referenced in the conversation.

The different classifications may be configured in a database, datastore, or a file. The classifications may be defined by the organization and provided to conversation controller 100 when deploying or initializing conversation controller 100 to run within the organization. Each classification may be associated with one or more identifiers, trackers, and/or directional anchors. For instance, an agent role of “sales” may be associated with a first classification, and an agent role of “support” may be associated with a second classification. Similarly, identifiers or trackers related to pricing, product advantages, and/or plan duration may be associated with the first classification, and identifiers or trackers related to product functionality, troubleshooting, and/or errors may be associated with the second classification.

DA-LLM 205 performs a domain-specific analysis of each conversation based on the directional anchors provided with that conversation. The domain-specific analysis includes performing a NLU evaluation of the conversation that is contextually-relevant for the conversation classification. For instance, the same word in a conversation may have different meaning or associations when analyzed with first context or with different second context. The directional anchors provide or associate the correct context for the NLU evaluation of the conversation. Moreover, the directional anchors dynamically configure DA-LLM 205 to analyze a conversation for different sets of trackers and metrics that are specific to the domain associated with the conversation classification. For instance, a first directional anchor for a “sales” conversation may cause DA-LLM 205 to analyze the transcript of a classified “sales” conversation for metrics related to pricing, product advantages, plan duration, and/or other contextually relevant trackers for a sales conversation, and a second directional anchor for a “support” conversation may cause DA-LLM 205 to analyze the transcript of a classified “support” conversation for metrics related to product functionality, troubleshooting, errors, and/or other contextually relevant trackers for a support conversation.

DA-LLM 205 generates the domain-specific CSAT reports, conversation scores, insights, and lifecycle analysis based on the trackers, metrics, and additional domain-specific analysis of the conversation. Specifically, the directional anchors cause DA-LLM 205 to generate CSAT reports, conversation scores, and insights that are specific to the determined domain or classification. In other words, the CSAT reports, conversation scores, and insights for conversations with different classifications will be derived from different trackers and metrics, and therefore included different data that is relevant for the different organizational domains associated with the different classifications or directional anchors.

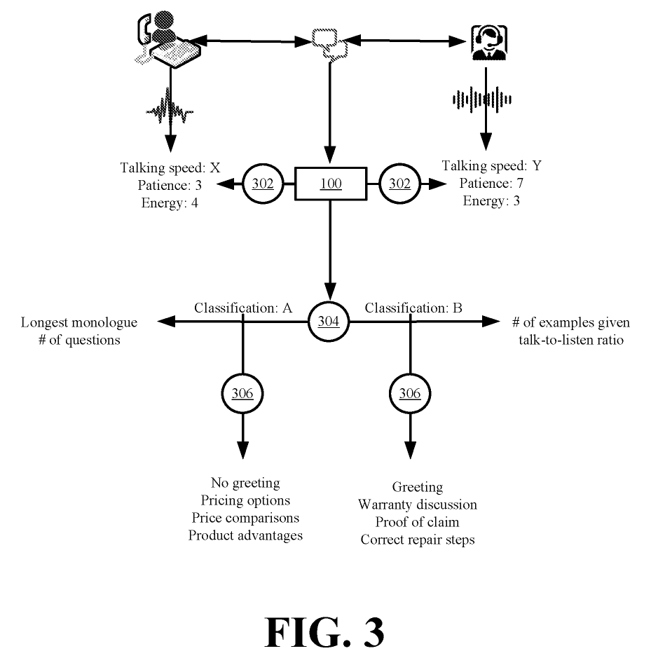

FIG. 3 illustrates an example of scoring a conversation in accordance with some example embodiments. Conversation controller 100 scores the conversation across multiple distinct metric categories in order to provide a holistic evaluation of the conversation rather than a single dimensional evaluation of the conversation.

Conversation controller 100 generates (at 302) a first set of metrics based on each speaker’s speech pattern. The first set of metrics may include metrics for the talking speed, patience, energy, and/or speaking attributes of each speaker.

Conversation controller 100 may isolate each speaker’s voice in a conversation before analyzing the rate at which each speaker speaks and/or variations in that speaker’s talking speed. Conversation controller 100 may objectively quantify the talking speed based on optimal ranges that are configured or learned by conversation controller 100.

Conversation controller 100 generates the patience metric by analyzing the speech pattern to identify pauses and measured responses by the different speakers. Conversation controller 100 may objectively quantify the speaker patience based on configured or learned values. For instance, conversation controller 100 may quantify speaker patience differently for a sales conversation than for a support conversation. More patience may be desired for the sales conversation so as to not pressure the customer, whereas less patience may be desired for the support conversation so as to appear responsive and knowledgeable to the customer’s concerns.

Conversation controller 100 may derive the energy metric from variations in the articulation, prosody, pitch, and/or other characteristics of a speaker’s voice. The energy metric may be used to objectify communication clarity and engagement.

Conversation controller 100 generates (at 304) a second set of metrics that are specific for the conversation classification. For instance, conversation controller 100 may generate (at 304) the second set of metrics to include metrics for the longest monologue and the number of questions asked for a conversation with “sales” classification, and may generate (at 304) the second set of metrics to includes metrics for examples given and talk-to-listen for a conversation with a “support” classification.

Conversation controller 100 determines the longest monologue metric by identifying the duration of the longest uninterrupted monologue in a given conversation and by quantifying monologue tendencies during the conversation. Quantifying the monologue tendencies may include determining sentence length and tone fluctuation as some examples.

Conversation controller 100 determines the number of questions asked from words usage (e.g., what, where, when, how, why, etc.) and based on speaker tone and/or inflection. Conversation controller 100 may also determine the number of questions asked based on question-and-answer exchanges in the transcript.

Conversation controller 100 may determine additional conversation metrics for other conversation classification. For instance, the effectiveness of agents that train customers on a product or service may be gauged on the number of examples or demonstrations that the agents provide to each customer. The provided examples or demonstrations may be a measure for determining the number of product features the customer is exposed to and/or the comprehensiveness of the training. Conversation controller 100 may determine the number of examples given in a conversation based on shared screen actions, sentence structure (e.g., step 1, step 2, etc.), and/or stating sequences associated with a specific example or demonstration in a script.

The talk-to-listen metric identifies the ratio between each participant’s speaking time and listening time. The talk-to-listen metric is a measure of the communication balance and/or participant engagement.

Conversation controller 100 generates (at 306) a third set of metrics based on a NLU analysis of the conversation. The third set of metrics may include items from a script or checklist that should be discussed in a conversation with a given classification, specific information to discuss or provide as part of a conversation with a given classification, accuracy of the information that was given, a listing of topics or subject matter that was discussed, and/or other derived metrics from the NLU analysis of the conversation.

The third set of metrics are customizable for each conversation classification. For instance, the DA-LLM may receive different conversations with the same classification, may analyze the different conversation for semantic commonality, trends, or patterns, and may define the metrics based on the detected commonality, trends, or patterns.

Conversation controller 100 generates a conversation score and various conversation insights for a particular conversation by using the DA-LLM to answer a set of domain-specific questions based on the combination of first, second, third, and/or other sets of metrics that are generated for that particular conversation and a NLU analysis of the conversation dialogue. The conversation score provides a holistic evaluation of the conversation that accounts for what was said, how it was said, and the relevance of what was said to the conversation classification. In other words, conversation controller 100 does not use the same evaluation for conversations that have different classifications and/or that apply to different domains or workflows. Instead, conversation controller 100 evaluates the conversations specifically in the context of the domain or workflow that the conversation applies (as determined from the classification) and/or according to the optimal practices established for that domain or workflow.

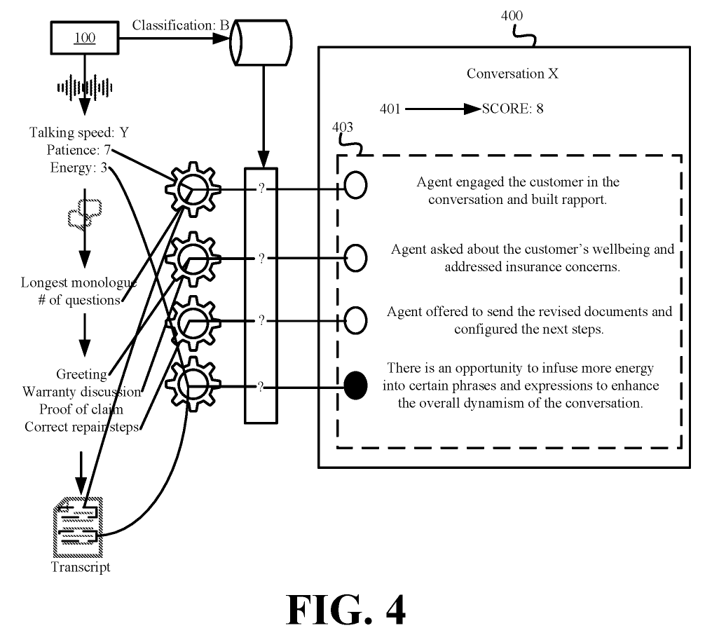

FIG. 4 illustrates an example interface 400 for a conversation score generated by conversation controller 100 in accordance with some example embodiments presented herein. Interface 400 may include numerical value 401 that quantifies the overall quality of a conversation as gauged from the different sets of metrics pertaining to the different analyzed dimensions of the conversation. Included with numerical value 401 are insights 403 that are derived from the different sets of metrics used to generate the numerical value or score.

Insights 403 identify specific strengths and/or weaknesses that conversation controller 100 detected during the conversation evaluation. As each conversation is different, score interface 400 will include different insights for each conversation.

Conversation controller 100 may generate insights 403 based on domain-specific evaluation of the domain-specific metrics. In some example embodiments, conversation controller 100 retrieves a set of questions (e.g., textual strings) that are defined or configured for the classification associated with the analyzed or scored conversation. Accordingly, different sets of questions may be defined or configured for different conversation classifications. Conversation controller 100 answers each question from the retrieved set of questions based on a NLU analysis of the question, the conversation dialog, and the domain-specific metrics. For instance, a first question for generating a first insight 403 may ask whether the agent was polite while engaging with the customer. Conversation controller 100 may use NLU to understand the question, may scan the conversation dialogue for words associated with being polite (e.g., please, thank you, etc.) and sentences that engage the customer, may analyze the number of questions asked metric to assess the engagement, and may analyze the talk-to-listen metric to assess the politeness of the agent. In some example embodiments, conversation controller 100 may compare the domain-specific metrics against other metrics that are generated for similarly classified conversations in order to detect areas that were stronger and/or weaker in the conversation and to generate scores or insights for those areas of the conversation. Additionally, the domain-specific metrics may be compared against goals or objectives that are defined for the domain or conversation classification. The goals or objectives may be defined by managers or executives and specify the actions or behaviors expected from an agent conducting a conversation with a particular classification.

In some example embodiments, the metrics and insights generated by conversation controller 100 are continuously changing based on changing conversation dynamics and changing priorities within each conversation classification or domain. For instance, the sales team may receive a new product with new features that may improve sales when the agents take additional time to explain and demonstrate the new features, whereas previous products were better sold by price comparisons. Conversation controller 100 may automatically detect the changing conversation dynamics and changing priorities in the different conversation classifications, and may automatically update the metrics to reflect the changing conversation dynamics and priorities as well as the insights that are generated to emphasize or focus on the new or changing dynamics and priorities.

In some example embodiments, the changing conversation dynamics and priorities may originate from the team managers or policy setters. For instance, a team manager may instruct their agents to behave or operate differently in future conversations, and may rely on conversation controller 100 to provide insights as to which agents are complying with the team manager instruction and which agents are out of compliance. By accounting for the team manager feedback at the time it is issued, conversation controller 100 may more quickly adapt and produce metrics and insights that are relevant to the implemented changes. Accordingly, conversation controller 100 includes a human feedback loop for incorporating the user feedback with the automatically detected changing conversation dynamics and priorities when updating the analyzed metrics and the generated insights.

By adapting to the changing conversation dynamics and priorities, conversation controller 100 is able to move from generating general-purpose or the same insights for all conversations in an organization to generating domain-specific or category-specific insights to generating evolving domain-specific or category-specific insights that are temporally and contextually relevant. Moreover, conversation controller 100 may generate the temporally and contextually relevant domain-specific or category-specific insights without developing or fine-tuning a LLM for each classification or domain and without continually retraining the LLM models whenever a conversation dynamic or priority changes.

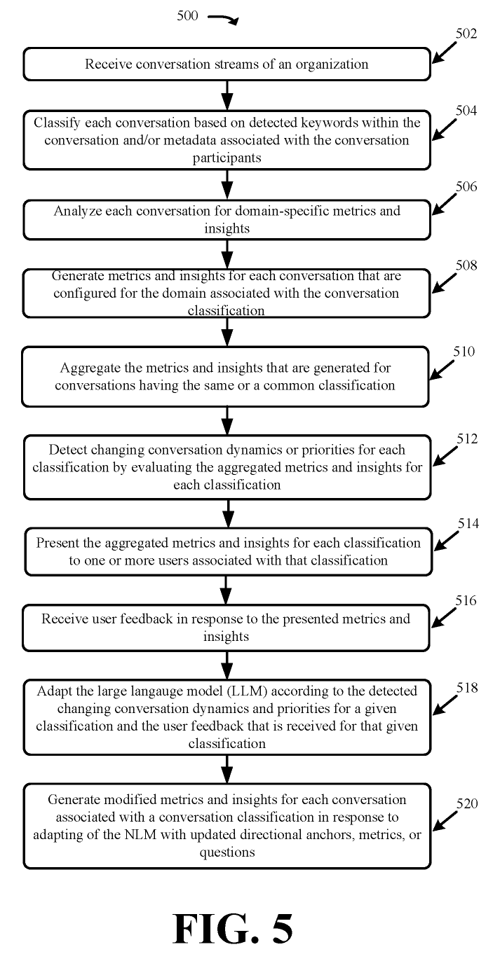

FIG. 5 presents a process 500 for dynamically adapting the conversation evaluation according to manually and automatically detected changing conversation dynamics and priorities in accordance with some example embodiments presented herein. Process 500 is implemented by conversation controller 100. More specifically, process 500 is implemented by one or more devices or machines of conversation controller 100 with processor, memory, storage, network, and/or other hardware resources that are configured to autonomously monitor conversations occurring within an organization and evaluate the conversations based on the changing conversation dynamics and priorities.

Process 500 includes receiving (at 502) conversation streams of an organization. Conversation controller 100 may receive (at 502) the audio, video, and/or textual streams of each conversation by integrating with the conferencing service provider or telecommunications service provider used by the organization.

Process 500 includes classifying (at 504) each conversation based on detected keywords within the conversation and/or metadata associated with the conversation participants. The conversation classifications may be preconfigured for the organization based on the services or types of conversations the agents of the organization have. For instance, a first organization may configure its instance of conversation controller 100 with classifications: “loan origination”, “loan default”, “loan refinance”, and “loan termination”. A second organization may configure its instance of conversation controller 100 with classifications: “product demonstration”, “trial”, “sales”, and “cancellation”.

Each configured classification may be associated with the one or more keywords and/or metadata that uniquely represent that classification. The one or more keywords may correspond to specific words in the conversation or may include subject matter or topic headings that may be matched to by different words in the conversation via a NLU or semantic mapping of the conversation words to the subject matter or topic heading. The metadata may include participant roles, device identifiers, telephone numbers, URLs, and/or other identifiers associated with the conversations that may be used for classification purposes.

Each configured classification may also be associated with one or more directional anchors that provide the context with which the DA-LLM evaluates the conversation. In some example embodiments, the classifications directly map to the directional anchors. In some other example embodiments, the directional anchors correspond to contextual keywords commonly associated with the classification.

Process 500 includes analyzing (at 506) each conversation for domain-specific metrics and insights. The conversation analysis (at 506) includes providing the conversation (e.g., the received (at 502) streams or feeds for the conversation) with the directional anchors for the determined classification as inputs to the DA-LLM. The directional anchors specify the context with which the DA-LLM is to evaluate the conversation. In particular, the directional anchors cause the DA-LLM to apply domain-specific context when analyzing (at 506) each conversation rather than the same context or no context to all conversations.

Process 500 includes generating (at 508) metrics and insights for each conversation that are configured for the domain associated with the conversation classification. The metrics and insights generated (at 508) for a particular conversation are stored or otherwise associated with that particular conversation.

Process 500 includes aggregating (at 510) the metrics and insights that are generated for conversations having the same or a common classification. In other words, conversation controller 100 groups the metrics and insights that are generated for all sales conversations separate from the metrics and insights that are generated for all support conversations.

Process 500 includes detecting (at 512) changing conversation dynamics or priorities for each classification by evaluating the aggregated (at 510) metrics and insights for each classification. Conversation controller 100 detects (at 512) the changing conversation dynamics or priorities when a pattern or trend arises around a particular metric or insight as opposed to the particular metric or insight having a random distribution of values for that classification. As a specific example, conversation controller 100 may detect (at 512) a changing conversation dynamic in response to a threshold number of conversations (e.g., more than 50%) with a loan origination classification having an incomplete metric and/or an insight specifying that the loan origination was incomplete due to a particular information request (e.g., a request additional financial statements beyond bank records and payroll statements). In this example, the priority or importance of the incomplete metric or insight specifying that the loan origination has changed (e.g., increased) as a result of the detected (at 512) trend or pattern.

Conversation controller 100 automatically changes the conversation dynamics or priorities so that additional or different metrics or insights are provided for better understanding of the trend, pattern, or the reasons behind the trend or pattern. However, conversation controller 100 also accounts for user-specified changes to the conversation dynamics or priorities prior to or as part of making any changes to the metrics or insights that are derived for conversations of the same classification. Accordingly, process 500 includes presenting (at 514) the aggregated (at 510) metrics and insights for each classification to one or more users associated with that classification. The one or more users may include managers, policy makers, and/or other decision makers associated with the classification. In some example embodiments, conversation controller 100 presents (at 514) the questions or prompts that the DA-LLM uses to generate the aggregated (at 510) metrics and insights for a classification.

Process 500 includes receiving (at 516) user feedback in response to the presented (at 514) metrics and insights. The user feedback may be linked to specific metrics or insights. For instance, a presented insight may specify “The agent was not able to resolve the customer’s issue or provide immediate assistance”. The user feedback that is linked to that insight may specify “Ask more open-ended questions and attempt to explain first how the product works”. The user feedback may include adding, removing, or reprioritizing the metrics that are analyzed in a given classification, adding, removing, or modifying the trackers with which conversation controller 100 detects words or values for the metrics, adding, removing, or modifying the questions used by the DA-LLM to generate the insights.

Process 500 includes adapting (at 518) the DA-LLM according to the detected (at 512) changing conversation dynamics and priorities for a given classification and the user feedback that is received (at 516) for that given classification. Adapting (at 518) the DA-LLM does not require retraining or refining of the DA-LLM. In some example embodiments, adapting (at 518) the DA-LLM includes modifying the trackers for a given classification that the DA-LLM uses to detect and generate the metrics. More specifically, modifying the trackers causes the DA-LLM to identify new or different metrics by isolating or focusing on different aspects or parts of a conversation. In some example embodiments, adapting (at 518) the DA-LLM includes changing the questions that the DA-LLM applies when performing the NLU analysis of the conversation. For instance, the DA-LLM receives the questions and textual prompts or inputs, and uses NLU to answer the questions based on the words, expressions, content, and/or other data in a conversation. Accordingly, a LLM may be trained using all data from all domains (e.g., teams, departments, groups, etc.) of an organization, and conversation controller 100 may dynamically adapt the LLM to provide temporally and contextually relevant metrics and insights by changing one or more of the directional anchors, trackers, or questions that provide the context and target the LLM NLU on specific aspects of a conversation. There is no need to retrain the LLM when domain-specific needs change and there is also no need to train different instances of the LLM using only the data from single organization domain.

Process 500 includes generating (at 520) modified metrics and insights for each conversation associated with a conversation classification in response to adapting (at 518) of the DA-LLM with updated directional anchors, metrics, or questions for the contextually relevant NLU analysis. Since there is no retraining of the DA-LLM, the modified metrics and insights are generated (at 520) as soon as any change is made to the directional anchors, trackers, or questions that the DA-LLM uses to generate (at 520) the modified metrics and insights.

The individual conversation evaluations (e.g., metrics and insights generated for a single conversation) are useful in determining issues associated with a particular conversation. However, managers and policy setters may be more concerned with repeating issues or trending issues rather than one-off issues that are unrelated to one another and that occur infrequently and/or in isolation. The repeating issues or trending issues may be representative of incorrect practices, improper or insufficient training, or suboptimal workflows. The repeating issues may also represent moments of strengths or reveal best practices that increase the effectiveness of each agent. These repeating issues or trending issues are difficult to detect through manual inspection of individual conversations or scores and insights generated for each conversation. Accordingly, conversation controller 100 performs a cross-conversation evaluation to generate consolidated metrics and insights. Conversation controller 100 may generate personalized coaching models for a particular agent based on consolidated metrics and insights that are derived from conversations that the particular agent participated in, and may generate personalized coaching models for teams or groups within a particular classification based on consolidated metrics and insights that are derived from conversations with that particular classification.

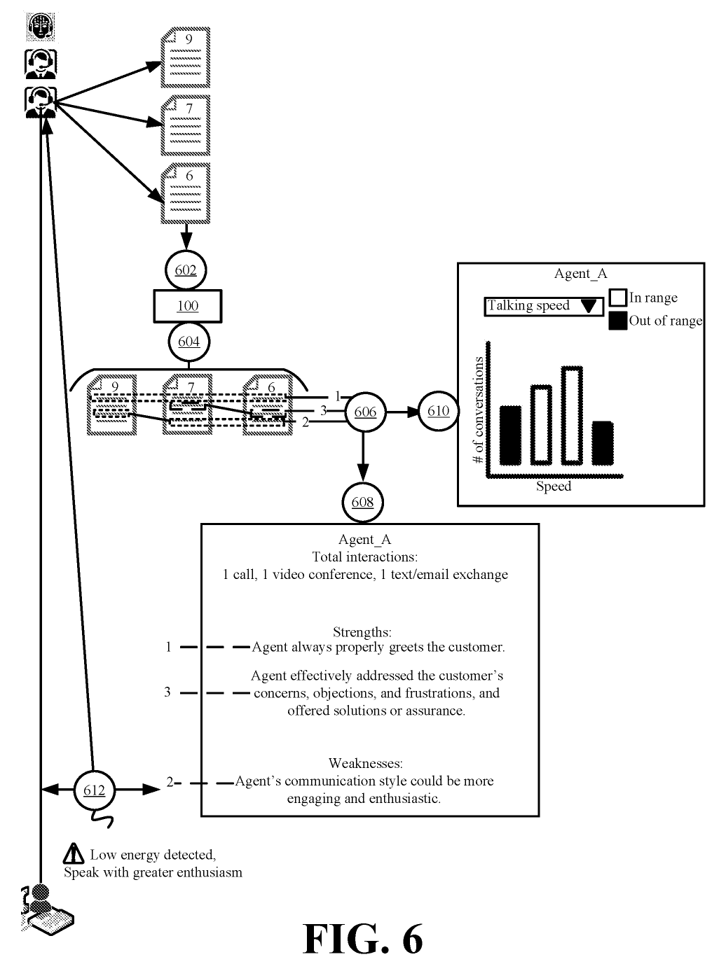

FIG. 6 illustrates an example of consolidated insights that are generated in accordance with some example embodiments presented herein. Conversation controller 100 aggregates (at 602) the metrics and insights that are generated for each conversation that involves a specific agent and/or that is classified with a common classification.

Conversation controller 100 identifies (at 604) matching or related insights. Related insights may have semantic similarity as a result of being directed to the same topic, subject, or issue. Related insights may also include insights that are derived from the same metrics.

Conversation controller 100 ranks (at 606) the matching or related insights based on frequency. In other words, conversation controller 100 assigns a higher rank to an insight the more times that insight repeats in the different conversations that the agent participated in.

Conversation controller 100 generates (at 608) the consolidated insights according to the ranking (at 606) of the matching or related insights. The consolidated insights include those insights that repeat in different conversations involving the agent, and are therefore good indicators of the strengths or weaknesses of that agent. The consolidated insights do not include insights that occurred in one conversation or in a very limited number of conversations. The infrequent insights could be one-off indicators, a result of interactions with an irregular customer, or when the agent was fatigued or having a bad day. In generating (at 608) the consolidated insights, conversation controller 100 curates a personalized and prioritized coaching interface for an agent when the metrics and insights are aggregated (at 602) for each conversation that involved that agent. Alternatively or additionally, conversation controller 100 may create a prioritized coaching interface for a team of agents based on metrics and insights that are aggregated (at 602) from the conversations involving any of the agents in the team.

When the metrics and insights are aggregated (at 602) from a large number of conversations, conversation controller 100 may provide a statistical analysis for individual metrics or insights. For instance, conversation controller 100 may generate (at 610) an interface that shows the talking speed of the agent in different conversations. A drop down box may be used to change the metric or insight that is presented in the interface.

Conversation controller 100 performs (at 612) a set of automated actions based on the consolidated insights. In some example embodiments, conversation controller 100 generates a coaching module in the form of a chatbot or interactive interface that instructs a given agent on procedures to resolve weaknesses at the top of the consolidated insights. In some such example embodiments, the coaching module may monitor an active conversation that the agent is involved in and may present prompts on the agent device when an agent weakness is detected. The prompts may notify the agent of the detected weakness in real-time (e.g., as it occurs in the active conversation) and may provide remedial actions to resolve or overcome the detected weakness. Alternatively, conversation controller may automatically modify a script that the agent follows in order to remove or edit parts where the agent demonstrates a weakness in the consolidated insights.

Customer feedback is another area of concern for organizations. For instance, at the completion of a conversation, a customer may be asked to remain on the line to answer some questions or may be emailed or otherwise presented with a set of questions to state their satisfaction as to various aspects of the conversation. Customers rarely provide feedback in these situations or may do so only when they are expressing anger or frustration. Accordingly, the received feedback may represent a small percentage of biased customers.

Conversation controller 100 may automate the customer feedback generation to improve the accuracy of the feedback and make the feedback more representative of all customers rather than a select subset of biased customers. In some example embodiments, conversation controller 100 generates a CSAT report or survey after each completed conversation by performing a NLU analysis of the conversation to automatically answer questions of the CSAT survey based on excerpts of the conversation that are contextually relevant or that directly answer the CSAT survey questions.

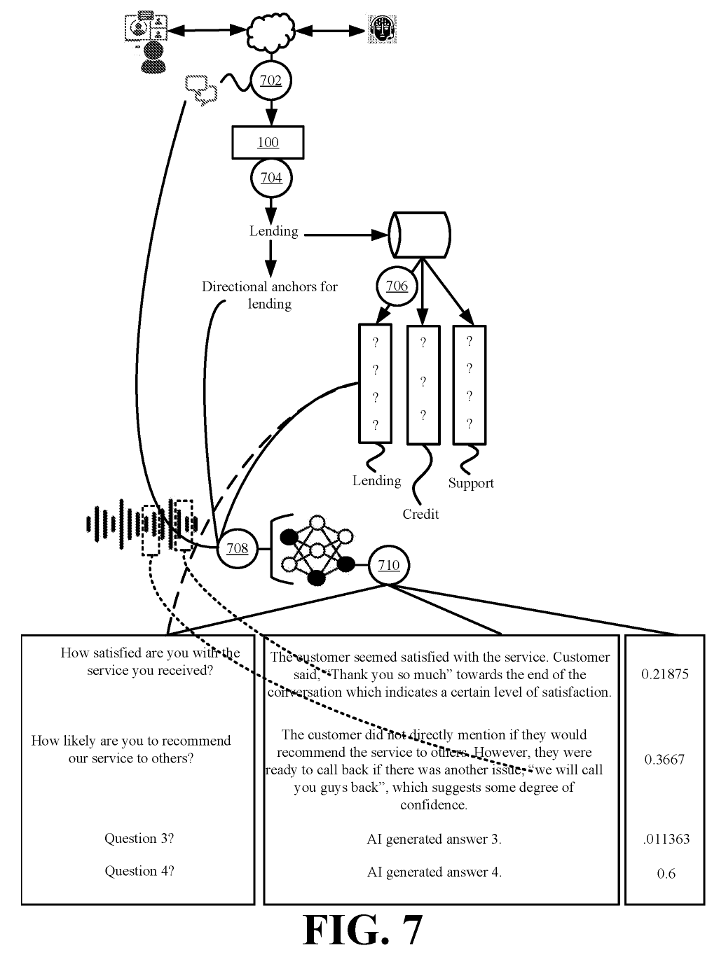

FIG. 7 illustrates an example of an automatically generated CSAT report in accordance with some example embodiments presented herein. Conversation controller 100 receives (at 702) a conversation and classifies (at 704) the conversation to determine that involves users or subject matter associated with a particular classification. Conversation controller 100 may produce a transcript of the dialogue exchanged during the conversation or may receive (at 702) textual messages that were exchanged by the conversation participants. In this example, the conversation is between a customer and a chatbot.

Conversation controller 100 retrieves (at 706) a CSAT questionnaire that is defined for the particular classification. The CSAT questionnaire is a set of questions for assessing customer satisfaction in conversations of the particular classification. Conversation controller 100 may be configured with different sets of CSAT questions for conversations occurring in different domains or conversations with different classifications. In other words, the retrieved (at 706) CSAT questionnaire includes questions that are determined to be important or relevant for assessing customer satisfaction in the domain associated with the particular classification. Each question may be written as a human-readable string. The questions may be drafted by a manager, supervisor, or other user with a quality control role in the particular classification.

Conversation controller 100 enters (at 708) the CSAT questionnaire with the received (at 702) conversation and directional anchors that are defined for the particular classification into the DA-LLM. The directional anchors provide context for interpreting the questions within the domain of the particular classification.

The DA-LLM uses NLU to analyze the questions and the conversation dialogue in the context of the domain associated with the directional anchors. More specifically, the DA-LLM analyzes the conversation dialogue and any metrics or trackers that are generated for the conversation for content that is related to and that answers each question of the CSAT questionnaire. In some example embodiments, the DA-LLM scans the conversation for keywords, sentiment, expressions, and/or behaviors that apply to a question from the CSAT questionnaire or that have semantic similarity to the wording of the question. In some cases, the DA-LLM may isolate multiple conversation segments to answer a question. For instance, the question may ask “How comfortable were you during the conversation?”. The DA-LLM may identify different parts of the conversation in which the customer expressed a sentiment or emotion, and may answer the question based on the cumulative sentiment or an average of the sentiment.

Conversation controller 100 generates (at 710) an answer to each question of the CSAT questionnaire and/or a numerical score to quantify the answer that is supported by one or more segments from the conversation. The answer is generated (at 710) in a human readable form. For instance, conversation controller 100 may generate one or more sentences that answer a question by summarizing different exchanges between the customer and an agent that relate to the question. Generating (at 710) the answer may also include linking the relevant conversation segments used to generate the answer to the answer. Accordingly, if a user selects an answer, the relevant conversation segments may be presented with the answer to evidence the support for the answer. A CSAT score may be generated for each answer and for the overall CSAT report. The CSAT score may represent a sentiment and/or confidence value associated with each answer and may be based on the amount of consistent evidentiary support from the conversation, generated metrics, and/or generated trackers that are used to generate (at 710) each answer. For instance, a lower CSAT score may be assigned to the answer that is generated (at 710) for the question “How satisfied were you with the service?” if the DA-LLM detects the customer being angry and frustrated at one point in the conversation and happy at another point in the conversation. A higher CSAT score may be assigned to the answer that is generated (at 710) for the question “How knowledgeable was the agent?” if the DA-LLM detects multiple responses from the agent that directly and correctly answered the customer’s questions.

The function of conversation controller 100 extends beyond conversational analysis and insight generation. The function of conversation controller 100 extends to automating control over the conversations. The automated control may include optimizing organizational workflows by identifying and modifying stages within the organizational workflows that hinder or complicate the completion of the workflows and/or the organization from meeting its objectives.

Detecting where the issues lie within a workflow is complicated by the fact that progression through the workflow may occur over multiple different conversations that take place at different times and/or with different personnel. Moreover, the customer progression through a workflow may not be sequential or linear given that the conversations may jump between the different stages, skip certain stages, or go backwards depending on how each conversation unfolds. The workflow progression is based on a set of conversations in which a single question or a single answer may change the workflow stage or move the conversation off the workflow.

Accordingly, conversation controller 100 generates conversational intelligence funnels that attribute different conversations involving the same workflow and the same customer and that take place at different times to the same customer lifecycle. Conversation controller 100 analyzes the different conversations within each conversational intelligence funnel to determine the progression through the implicated workflow and to generate insights or reasons for the rate of progression and/or early termination before the workflow is complete. Conversation controller 100 combines the conversational intelligence funnels for different customer lifecycles progressing through the same workflow in order to generate consolidated insights from which the automated conversation controls are implemented.

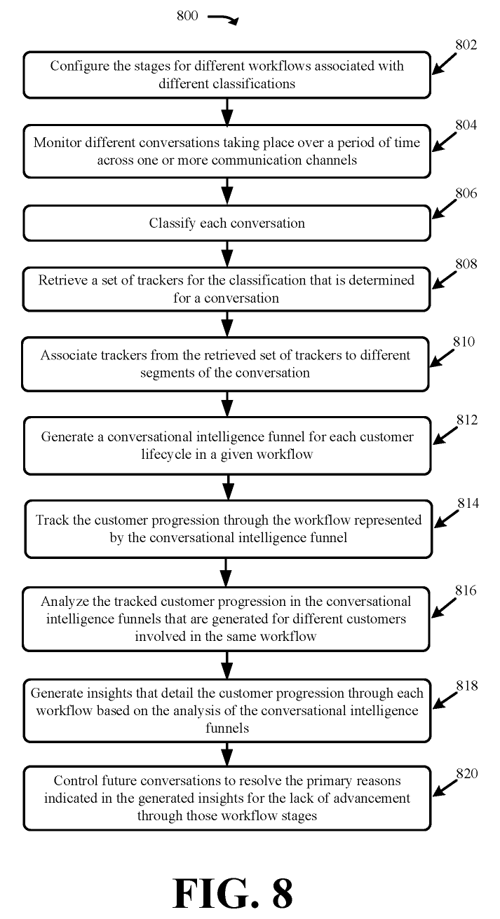

FIG. 8 presents a process 800 for automating control over conversations associated with one or more workflows based on generated conversational intelligence funnels in accordance with some example embodiments presented herein. Process 800 is implemented by conversation controller 100.

Process 800 includes configuring (at 802) the stages for different workflows associated with different classifications. At a minimum, conversation controller 100 is configured (at 802) with the start and end stages for each workflow that is associated with a different classification. For instance, a workflow for lending may include a start stage for “verifying borrower eligibility” and an end stage of “loan approval”. Other stages in this workflow may include “understanding the application procedure”, “details on loan products”, “stipulations on loan products”, “disclosure of interest rates and fees”, and “dispatching loan application link”. Each configured (at 802) stage may be associated with one or more trackers or metrics by which conversation controller 100 is able to determine whether or not that stage has been reached and/or completed. For instance, the first stage of “verifying borrower eligibility” stage may be associated with a first set of trackers that include trackers for information or data that is required to verify the borrower eligibility. These trackers may include identifiers for age, profession, and annual salary. If conversation controller 100 detects these trackers in a conversation that is classified as a “lending” conversation, then conversation controller 100 may determine that the conversation or the part of the conversation where these trackers are found pertain to the first stage of the workflow.

Process 800 includes monitoring (at 804) different conversations taking place over a period of time across one or more communication channels. Monitoring (at 804) the different conversations includes receiving the audio, video, and data streams for the dialogue and/or messaging exchanged in each conversation between the conversation participants.

Process 800 includes classifying (at 806) each conversation based on topics or subject matter discussed in the conversation, roles or metadata associated with the conversation participants, and/or content that is shared over the course of the conversation. Classifying (at 806) each conversation includes one or more directional anchors that specify the domain associated with the classification and/or that provide domain-specific context to the conversation.

Process 800 includes retrieving (at 808) a set of trackers for the classification that is determined for a conversation. The set of trackers may represent the features, elements, or parts of a conversation that are important or relevant for the domain to which the classification for the conversation belongs.

Process 800 includes associating (at 810) trackers from the retrieved (at 804) set of trackers to different segments of the conversation in response to analyzing the conversation and detecting keywords, identifiers, sentiment, behavior, and/or other user actions in those conversation segments that match the definition of the associated (at 810) tracker. For instance, an angry sentiment tracker may be associated (at 810) to a first conversation segment in which the speaker’s voice is raised and words such as “hate” or “no” are used in that conversation segment, and a “loan origination” tracker may be associated (at 810) to a second conversation segment in which the customer profession or annual salary is mentioned.

Process 800 includes generating (at 812) a conversational intelligence funnel for each customer lifecycle in a given workflow. Generating (at 812) the conversation intelligence funnel includes grouping in each conversational intelligence funnel two or more conversations that have the same classification, that involve the same customer or user, and/or that relate to the same workflow. In some example embodiments, the classification or the domain associated with the classification may indicate the workflow that the conversation relates to. The customer or user identification may be determined based on one or more identifiers that are used to contact the customer (e.g., a telephone number, email address, or other network address), that uniquely identify the customer device (e.g., device fingerprint), that are provided during the conversation (e.g., the user name or a user profile that is accessed by the customer through a login procedure or that an agent pulls up during a conversation), and/or words that are spoken during the conversation (e.g., a greeting in which the customer identifying information is spoken).

Process 800 includes tracking (at 814) the customer progression through the workflow represented by the conversational intelligence funnel based on a matching of the associated (at 810) conversation trackers and/or metrics to the different stages that are configured (at 802) for the workflow.

Process 800 includes analyzing (at 816) the tracked (at 814) customer progression in the conversational intelligence funnels that are generated (at 812) for different customers involved in the same workflow. The analysis (at 816) includes determining the rate at which the different customers advance to the different workflow stages based on the time between the conversations that are matched to each workflow stage. The analysis (at 816) includes determining whether the customer lifecycle in each conversational intelligence funnel is still active or has ended. The determination as to the status of the customer lifecycle involves conversation controller 100 analyzing the conversation or conversation segment that was matched or attributed to the latest stage in the workflow. Specifically, conversation controller 100 analyzes the words, sentiment, and/or user actions for indications of an active or inactive customer lifecycle. Indications of an active customer lifecycle include requests for follow-up appointments or conversations, requests for information or data, and/or other messaging that the customer will resume the workflow or conversation at a later time. Indications of an inactive customer lifecycle include statements that the customer is not interested, wants to be removed from a contact list, wants to cancel service, is angry, will not perform next steps, and/or other messaging that the customer does not wish to resume the workflow or conversation.

Process 800 includes generating (at 818) insights that detail the customer progression through each workflow based on the analysis (at 816) of the conversational intelligence funnels. Conversation controller 100 detects trends, patterns, or commonality for the progression to each stage of a workflow. For instance, a detected trend, pattern, or commonality may include determining that requests for personal identifying information (e.g., a social security number) and customers unwillingness to provide the personal identifying information at a particular stage of a workflow was the most common reason that the customers ended the customer lifecycle at the particular stage. Generating (at 818) the insights may include ranking the insights based on the frequency with which the detected trend, pattern, or commonality occurs at the same stage in the workflows associated with different customers. For instance, the insights may specify the top 3 reoccurring reasons why different customers in the analyzed conversations terminated the workflow at each stage (e.g., reason 1: customers are not interested in sharing social security number details, reason 2: customers did not like the terms and conditions, and reasons 3: customer are not clear about the additional charges). Generating (at 818) the insights may include presenting cumulative metrics for the number of active and inactive customers at each stage of a workflow and the primary reasons for the progression to each stage of the workflow.

Process 800 includes controlling (at 820) future conversations to resolve the primary reasons indicated in the generated (at 818) insights for the lack of advancement through those workflow stages. Controlling (at 820) the future conversations may include modifying one or more workflow stages where there is a large number or percentage of customers ending the workflow before the final stage. Conversation controller 100 may remove the bottleneck workflow stage or revise the scripts or information that is requested at those stages. Controlling (at 820) the future conversations may include reconfiguring chatbots that engage with customers at those stages to generate different responses when faced with one of the detected primary reasons for premature ending of the customer lifecycle, and activating the chatbots in response to receiving a new conversation request for a customer that is at one or more of those stages in the workflow. In any case, conversation controller 100 controls (at 820) the future conversations by performing a set of automated actions that optimize the workflows based on the tracked customer feedback, wherein optimizing the workflows includes removing the pain points that are the main reasons behind the customer lifecycles ending before the reaching the final workflow stage.

The embodiments presented above are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the above descriptions are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (“IoT”) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (“RAM”), read only memory (“ROM”), electrically erasable programmable ROM (“EEPROM”), flash memory, or other memory technology, compact disk ROM (“CD-ROM”), digital versatile disks (“DVDs”) or other optical storage, solid state drives, hard drives, hybrid drive, or any other medium that can be used to store the desired information and that can be accessed to retrieve that information.

It is appreciated that the presented systems and methods can be implemented in a variety of architectures and configurations. For example, the systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments. It should be understood, that terms “user” and “participant” have equal meaning in the following description.

1. A computer-implemented method for controlling conversations in an organization, the computer-implemented method comprising:
monitoring a plurality of conversations involving a different sets of participants over a period of time;
detecting a first set of trackers in a first conversation and in a second conversation of the plurality of conversations that occur at different times over the period of time;
detecting a second set of trackers in a third conversation and in a fourth conversation of the plurality of conversations that occur at different times over the period of time;
updating a first customer lifecycle based on the first set of trackers from the first conversation, the second set of trackers from the third conversation, and the first conversation and the third conversation involving a common first customer;
updating a second customer lifecycle based on the first set of trackers from the second conversation, the second set of trackers from the fourth conversation, and the second conversation and the fourth conversation involving a common second customer;
generating different insights for the first customer lifecycle and the second customer lifecycle ending at a particular stage of a workflow based on the second set of trackers and a natural language understanding (NLU) of dialogue from the third conversation and the fourth conversation; and
modifying an action that is performed in an active conversation involving a third customer in response to the different insights indicating an issue at the particular stage of the workflow and determining that a customer lifecycle of the third customer is at the particular stage of the workflow.

2. The computer-implemented method of claim 1, further comprising:
classifying each conversation of the plurality of conversations to one of a plurality of different domains.

3. The computer-implemented method of claim 2, further comprising:
associating one or more directional anchors, that are configured for a particular domain, to each of the first, second, third, and fourth conversations in response to classifying the first, second, third, and fourth conversations to the particular domain.

4. The computer-implemented method of claim 3, further comprising:
analyzing dialogue from the first, second, third, and fourth conversations in a context of the particular domain based on the one or more directional anchors attributing the context to words or phrases from the first, second, third, and fourth conversations.

5. The computer-implemented method of claim 1, wherein modifying the action comprises:
generating a new response from a chatbot in response to the chatbot receiving a prompt that raises the issue in the active conversation with the third customer at the particular stage of the workflow.

6. The computer-implemented method of claim 1, wherein modifying the action comprises:
removing a request for information from the particular stage of the workflow.

7. The computer-implemented method of claim 1, wherein modifying the action comprises:
modifying an answer that agents provide to a question at the particular stage of the workflow.

8. The computer-implemented method of claim 1, wherein modifying the action comprises:
configuring a chatbot with generative content that resolves the issue; and
activating the chatbot in response to establishing the active conversation with the third customer at the particular stage of the workflow.

9. The computer-implemented method of claim 1, wherein modifying the action comprises:
detecting that the active conversation involves the particular stage of the workflow, the third customer, and an agent; and
generating a prompt on a device of the agent, wherein the prompt provides generative content for resolving the issue.

10. The computer-implemented method of claim 1, wherein the first set of trackers are associated with a first stage of the workflow and the second set of trackers are associated with the particular stage of the workflow.

11. The computer-implemented method of claim 1, further comprising:
aggregating a plurality of different customer lifecycles that progress through the workflow, wherein the plurality of different customer lifecycles includes the first customer lifecycle and the second customer lifecycle; and
ranking a plurality of issues affecting different stages of the workflow based on a frequency with which each issue of the plurality of issues occurs in the plurality of different customer lifecycles.

12. The computer-implemented method of claim 1, wherein generating the different insights comprises:
determining a first reason that the first customer mentions in the dialogue of the third conversation for not advancing past the particular stage of the workflow;
determining a second reason that the second customer mentions in the dialogue of the fourth conversation for not advancing past the particular stage of the workflow;
determining that the first reason and the second reason are related; and
generating the issue in response to determining that the first reason and the second reason are related.

13. The computer-implemented method of claim 1, wherein monitoring the plurality of conversations comprises:
receiving one or more of an audio stream, video stream, or text stream associated with each conversation of the plurality of conversations.

14. The computer-implemented method of claim 1, wherein monitoring the plurality of conversations comprises:
integrating with a system that establishes the plurality of conversations between the different sets of participants; and
receiving a forwarded stream from each conversation of the plurality of conversations from the system.

15. A conversation controller that provides automated conversation control, the conversation controller comprising:
one or more hardware processors configured to:
monitor a plurality of conversations involving a different sets of participants over a period of time;
detect a first set of trackers in a first conversation and in a second conversation of the plurality of conversations that occur at different times over the period of time;
detect a second set of trackers in a third conversation and in a fourth conversation of the plurality of conversations that occur at different times over the period of time;
update a first customer lifecycle based on the first set of trackers from the first conversation, the second set of trackers from the third conversation, and the first conversation and the third conversation involving a common first customer;
update a second customer lifecycle based on the first set of trackers from the second conversation, the second set of trackers from the fourth conversation, and the second conversation and the fourth conversation involving a common second customer;
generate different insights for the first customer lifecycle and the second customer lifecycle ending at a particular stage of a workflow based on the second set of trackers and a natural language understanding (NLU) of dialogue from the third conversation and the fourth conversation; and
modify an action that is performed in an active conversation involving a third customer in response to the different insights indicating an issue at the particular stage of the workflow and determining that a customer lifecycle of the third customer is at the particular stage of the workflow.

16. The conversation controller of claim 15, wherein the one or more hardware processors are further configured to:
classify each conversation of the plurality of conversations to one of a plurality of different domains.

17. The conversation controller of claim 16, wherein the one or more hardware processors are further configured to:
associate one or more directional anchors, that are configured for a particular domain, to each of the first, second, third, and fourth conversations in response to classifying the first, second, third, and fourth conversations to the particular domain.

18. The conversation controller of claim 17, wherein the one or more hardware processors are further configured to:
analyze dialogue from the first, second, third, and fourth conversations in a context of the particular domain based on the one or more directional anchors attributing the context to words or phrases from the first, second, third, and fourth conversations.

19. The conversation controller of claim 15, wherein modifying the action comprises:
generating a new response from a chatbot in response to the chatbot receiving a prompt that raises the issue in an active conversation with a third customer at the particular stage of the workflow.

20. A non-transitory computer-readable medium storing program instructions that, when executed by one or more hardware processors of a conversation controller for automated conversation control, cause the conversation controller to perform operations comprising:
monitoring a plurality of conversations involving a different sets of participants over a period of time;
detecting a first set of trackers in a first conversation and in a second conversation of the plurality of conversations that occur at different times over the period of time;
detecting a second set of trackers in a third conversation and in a fourth conversation of the plurality of conversations that occur at different times over the period of time;
updating a first customer lifecycle based on the first set of trackers from the first conversation, the second set of trackers from the third conversation, and the first conversation and the third conversation involving a common first customer;
updating a second customer lifecycle based on the first set of trackers from the second conversation, the second set of trackers from the fourth conversation, and the second conversation and the fourth conversation involving a common second customer;
generating different insights for the first customer lifecycle and the second customer lifecycle ending at a particular stage of a workflow based on the second set of trackers and a natural language understanding (NLU) of dialogue from the third conversation and the fourth conversation; and
modifying an action that is performed in an active conversation involving a third customer in response to the different insights indicating an issue at the particular stage of the workflow and determining that a customer lifecycle of the third customer is at the particular stage of the workflow.
